(19) United States
(12) Patent Application Publication
(10) Pub. No.: US 2001/0048062 A1
(43) Pub. Date: Dec. 6, 2001

(54) Auxiliary machine mounting structure for an engine

(76) Inventors: Kazushige Murao, Kariya-shi (JP); Shigeyuki Hidaka, Kariya-shi (JP); Masashiko Okada, Kariya-shi (JP)

Correspondence Address: MORGAN & FINNEGAN, L.L.P., 345 Park Avenue, New York, NY, 10154, US

(21) Appl. No.: 09/821,324

(22) Filed: Mar. 29, 2001

(30) Foreign Application Priority Data
Mar. 30, 2000 (JP) 2000-092591

(51) Int. Cl. F16M 1/00

(52) U.S. Cl. 248/680

(57) ABSTRACT

As a conventional mounting structure, it was provided an auxiliary machine mounting structure for an engine such that a plural mounting portions formed integrally on the outer circumferential surface of an auxiliary machine and a bracket (a portion to be mounted) formed on engine were fastened by bolts. In such structure, as the mounting portions extended in the tangential direction of the machine, they protrude far in the radial direction of the main body of the machine. And it was requested that the structure enables to mount the machine to the bracket, whatever structure of the bracket is.

The present invention is such that four mounting portions are formed on a housing of a compressor as an auxiliary machine for an engine. A mounting hole formed in the mounting portion is constituted by the following two axes. One is the axis substantially right-angle to a mounting surface of the mounting portion and the other is the axis which is inclined at predetermined angle to the above axis in the tangential direction of the housing. The intersection of the two axes is positioned such that the distances between the intersection and the opposite openings are equal.

### BACKGROUND OF THE INVENTION

The present invention relates to an auxiliary machine mounting structure for an engine.

Conventionally, it is provided an auxiliary machine mounting structure for an engine such that a plural mounting portions formed integrally on the outer circumferential surface of an auxiliary machine and a bracket (a portion to be mounted) formed on an engine are fixed by bolts.

In Japanese Unexamined Utility Model Publication 2-43478, mounting structure of a compressor as the auxiliary machine is disclosed. It is shown in FIG. 5 in attached drawings. The compressor 50 is constituted by mounting portions 52 provided with a mounting hole 51, respectively, through which a bolt 55 is inserted, and a main body 58. The mounting portions 52 and the main body 58 are formed integrally. In a bracket 54 to which the compressor 50 is to be mounted, tapped holes 56, through which bolts 55 are to be threaded, respectively, are formed. The compressor 50 is fixed to the bracket 54, by inserting bolts 55 into the mounting holes 51 and by threading into the tapped holes 56.

In Japanese Unexamined Utility Model Publication 7-14178, another compressor mounting structure is disclosed. The compressor 60 in FIG. 6 is constituted by four mounting portions 61, 61, 63, 63 and a main body 65. The mounting portions 61, 61 are arranged at the upper side of the main body 65. The mounting portions 63, 63 are arranged at the lower side of the main body 65. Each of four mounting portions 61, 61, 63, 63 is extended in perpendicular direction to the axis of the drive shaft of the compressor 60, and such that those hold the main body 65 therebetween. In the longitudinal direction of each mounting portion 61, 61, 63, 63; mounting holes 62, 62, concave grooves 64, 64 are formed to penetrate therethrough, respectively. In a bracket on which the compressor 60 is to be mounted, tapped holes through which bolts are to be threaded are formed at the positions corresponding to the mounting hole 62, 62 and the concave groove 64, 64.

The compressor 60 is fastened to the bracket as follows. First, a bolt to be engaged with the concave groove 64 is preliminarily fastened to the bracket. The compressor 60 is held by engaging to the above bolt. Then bolts are inserted through the mounting hole 62. Four inserted bolts are threaded and secured.

Recently, an engine compartment of a vehicle has less space than before. All the parts including engine in the engine compartment are requested to reduce the size and the weight. Naturally, all the mounting structure are requested to use the space efficiently, and an auxiliary machine mounting structure of an engine is requested to reduce the size.

The mounting structure disclosed in Japanese Unexamined Utility Model Publication 2-43478 necessitates such clearance that the head portion of which diameter is larger than that of the threaded portion of the bolt 55 does not interfere with the main body 58. The mounting portion 52 protrudes far radially outwardly from the main body 58.

The mounting structure disclosed in Japanese Unexamined Utility Model Publication 7-14178 is such that the mounting portions 61, 63 extend outside of the main body 65. Therefore, in this case, the mounting portion 61, 63 protrude in the radial direction of the main body 65, too. As the structure is such that the concave groove 64, 64 are engaged to two preliminarily fastened bolts, the bolts are requested to be fastened substantially horizontally. It also has a restriction in the mounting method. That is, two bolts are preliminarily fastened, and then the compressor 60 is mounted such that the opening of the concave groove 64 is opened downwardly. The auxiliary machine including compressor has different mounting positions and different mounting angles according to the installed vehicles. The order of inserting bolts also different. Therefore, a mounting structure has been requested to perform the suitable mounting.

### SUMMARY OF THE INVENTION

The present invention contemplates to alleviate the above mentioned inconveniences. The object is to provide an auxiliary machine mounting structure of an engine which enables to install the machine easily in a limited space of the engine compartment of a vehicle.

To achieve the above object, the present invention has a following feature. An auxiliary machine mounting structure for an engine, the structure is constituted by the auxiliary machine for the engine and plural mounting portions formed on an outer circumferential surface of the machine so as to protrude therefrom. The plural mounting portions are fixed firmly to a bracket of the engine by inserting bolts through each mounting hole bored in each mounting portion. Each mounting hole is longitudinal hole such that each bolt is inserted through the respective hole, having a predetermined angle to the axis of the bolt which is fastened to the engine.

According to the present invention, even though a protruding portion, which is an obstacle when a bolt is inserted through the hole, for example a housing of a main body of an machine, is on the extended axis of a bolt being fixed in a limited engine compartment of a vehicle, the bolt is easily inserted through the hole by tilting the axis of the bolt when the bolt is inserted with respect to the axis of the bolt when the bolt is fixed.

Furthermore, the present invention has a following feature. In the above structure, the above mounting hole is bored in each mounting portion, perpendicular to the drive shaft of the machine. The longitudinal direction of the longitudinal hole is the radial direction of a main body of the machine.

Furthermore, the present invention features that the above mounting hole is a tapered hole.

According to the present invention, as the above mounting hole is tapered, a constriction is formed to the nearer side, to the main body of the machine, of the inner circumferential surface of the hole. The constriction can support a part of the bolt. Therefore, the axis of the inserted bolt can be easily changed from the angle when the bolt is preliminarily fastened to the angle when the bolt is fixed.

Furthermore, the present invention features that the above mounting hole is a hole such as at least two axes intersect therein.

According to the present invention, the hole is easily machined by using a cutting tool such as a drill.

Furthermore, the present invention features that the above bolt is one with hexagon socket head or one with dodecagon socket head.

According to the present invention, the bolt is fastened and secured by using a ball point wrench. It also can reduce the space for inserting a tool to the head portion to fasten the bolt, by using a hexagon wrench key such as a rachet wrench.

### BRIEF DESCRIPTION OF THE DRAWINGS

The features of the present invention that are believed to be novel are set forth with particularity in the appended claims. The invention together with objects and advantages thereof, may best be understood by reference to the following description of the presently preferred embodiments together with the accompanying drawings in which:

FIG. 1 is a side view illustrating a compressor according to an embodiment of the present invention;

FIG. 2 is a cross-sectional view as seen from line I-I in FIG. 1;

FIG. 3(a) is a partial explanatory view illustrating a bolt to be inserted through a mounting hole according to the embodiment of the present invention;

FIG. 3(b) is a partial explanatory view illustrating a bolt to be fixed firmly through a mounting hole according to the embodiment of the present invention;

FIG. 4 is a partial explanatory view illustrating a compressor according to another embodiment of the present invention;

FIG. 5 is a side view illustrating a compressor according to a prior art; and

FIG. 6 is a side view illustrating a compressor according to another prior art.

### DETAILED DESCRIPTION OF THE PREFERRED EMBODIMENTS

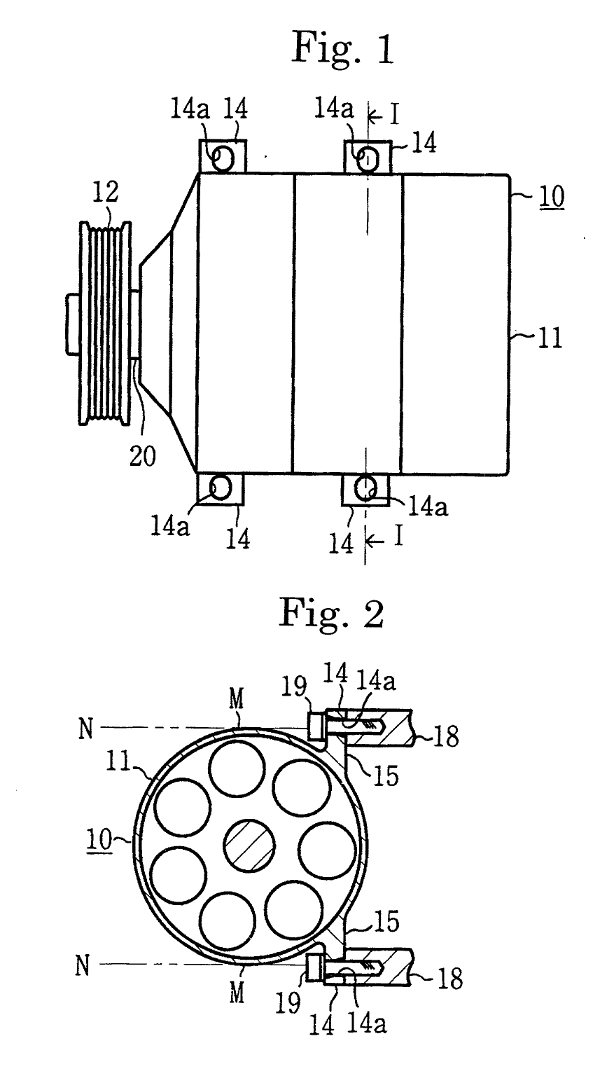

A compressor according to an embodiment of the present invention will now be described, referring drawing FIG. 1 to FIG. 3(b).

The front side in the embodiment indicates the left side (a pulley 12 side) in FIG. 1. The rear side of the embodiment indicates the right side in FIG. 1. As shown in FIG. 1 and FIG. 2, a main body, the pulley 12 and four mounting portions 14 formed on the outer circumferential surface of the main body of the compressor constitute a compressor. The main body of the compressor includes a housing 11 as a casing and a compressing mechanism accommodated inside of the housing 11. The pulley 12 is secured to the front end of a drive shaft 20 which is be connected with the compression mechanism.

Two mounting portions 14 are arranged at the front end portion and other two mounting portions 14 are arranged at the rear side, respectively, holding the housing 11. Each mounting portion 14 is such that its plane surfaces extend in radial direction of the housing 11. Mounting holes 14a extend in the thickness direction of the plate-like mounting portion. Bracket 18 of an engine extend to correspond to each mounting portion 14. Each mounting portion 14 is arranged on the bracket 18 side of the engine with respect to the contact point M between the tangentially extended axis N of the mounting hole 14a and the housing 11.

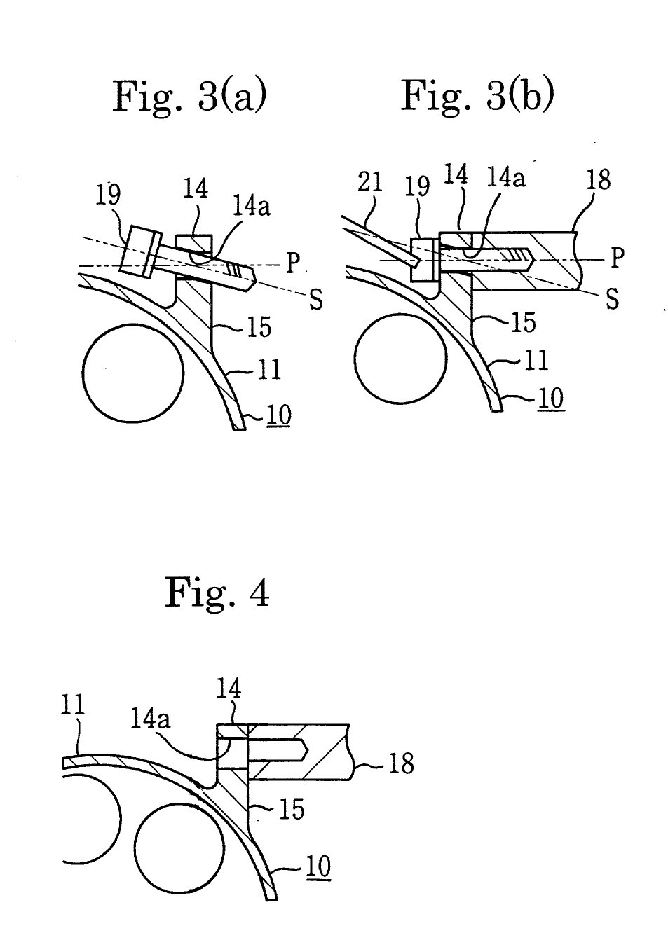

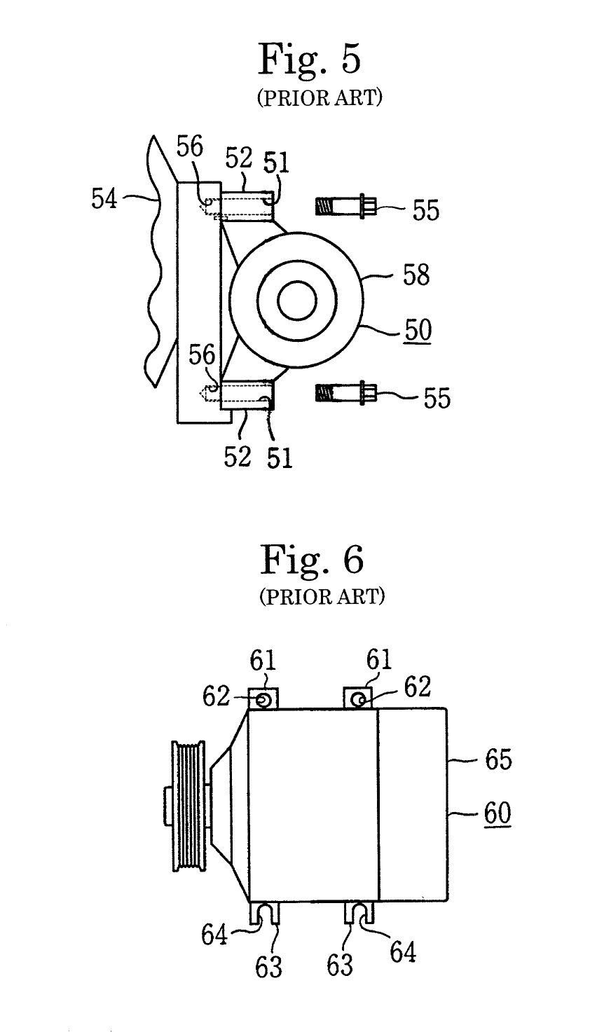

As shown in FIG. 3, the mounting hole 14a is constituted by the following bolt hole which has two axes. One is the axis P substantially right-angle to a mounting surface 15 of the mounting portion 14 and the other is the axis S which is inclined at a predetermined angle with respect to the axis P in a perpendicular plane with respect to the drive shaft 20. The axis P is substantially identical to the axis of the bolt when the bolt 19 is fixed firmly to the bracket 18. The axis S is substantially identical to the axis of the bolt 19 when the bolt 19 is inserted through the hole 14a. The intersection of two axes S and P is positioned such that the distances between the intersection and the opposite openings of the hole 14a are equal. That is, the cross section of the mounting hole 14a is reduced taperingly from the opposite openings. The cross section is minimized at the center of both openings. The sectional shape of the mounting hole 14a is substantially a longitudinal hole, and the longitudinal direction of the longitudinal mounting hole 14a is a radial direction of the housing 11.

Next, a method to mount the above constructed compressor to the engine is described, referring FIG. 3(a) and FIG. 3(b).

First, a bolt 19 which has a hexagon socket head is inserted through the mounting hole 14a, holding a compressor 10. The bolts 19 are preliminarily fastened to tapped holes bored in the bracket 18, in turn. In this case, one of the bolt 19 is preliminarily fastened first to a most suitable hole in the mounting holes 14a, and then another bolt 19 is preliminarily fastened in turn.

As shown in FIG. 3(a), the bolt 19 is inserted through the mounting hole 14a along with the axis S having a predetermined angle to the mounting surface 15, when the bolt 19 is preliminarily fastened to the mounting hole 14a. Then, as shown in FIG. 3(b), the bolt is inclined as its axis to be parallel to the axis P, and it is inserted through the tapped hole formed in the bracket 18. The bolt 19 is preliminarily fastened and secured, by using ball point wrench 21. The ball point wrench 21 is inserted into the hexagon socket head, obliquely to the axis P, then it is preliminarily fastened. Then, four bolts 19 which are preliminarily fastened are fixed firmly to the bracket 18 in turn by using the ball point wrench 21, as above preliminarily fastening.

The present embodiment has the following effects.

(1) As the mounting portions 14 are arranged in the bracket 18 side than the contact point M, they slightly protrude to upper and lower direction of the housing 11.

(2) The mounting hole 14a is formed only by twice drilling process.

(3) As the intersection between two axes S and P is positioned such as the distances between the opposite openings and the intersection are equal, each opening does not larger than it necessitates, and it does not lose strength.

(4) As all the mounting portions 14 have not grooves, but holes, a compressor 10 is preliminarily fastened to the bracket 18 by preliminarily fastening of first bolt 19, whichever mounting hole 14 is selected first.

(5) As shown in FIG. 3(b), the bolt 19 is inserted through the hole 14a along with the axis S which has a predetermined angle to the mounting surface 15, even though there is no space in the bolt insertion side to insert the bolt 19 through the hole 14a along with the extended axis P when the bolt 19 is fastened.

The embodiments are not limited to above structure, but also the followings are applicable.

The shape and the arrangement of the mounting hole 14a is not limited to the tapered shape as above embodiment. For example, the mounting hole 14a without constriction, but the longitudinal hole is applicable, as shown is FIG. 4.

The structure of the present invention is not limited to the number and the position of the mounting portion 14. If at least one mounting portion 14 employs a longitudinal mounting hole, it contributes to use the space of the engine compartment efficiently. For example, the mounting portions which have mounting holes extending longitudinally as shown in Japanese Unexamined Utility Model Publication No. 7-14178 may be formed at two positions in the front side of the main body of the compressor.

The mounting portions 14 do not necessarily limit to four portions. At least two portions are applicable.

All four bolts 19 may be fastened simultaneously. Such method enables to fix firmly the auxiliary machine to the bracket, without preliminarily fastening of the bolts.

The drilling process of the mounting hole 14a is not limited to twice, but once or plural times may be performed, by changing the angle of the drill. That is, the mounting hole 14a only necessitates to be formed by serial axis at predetermined angle.

The adjustment function may be added to the auxiliary machine mounting, by adjusting the longitudinal length of the mounting hole 14a.

The bolt 19 is not limited to the one with hexagon socket head or the one with dodecagon socket head. Naturally, the bolt may be fastened and secured to the bracket, using the tool other than the ball point wrench 21.

Therefore the present examples and embodiments are to be considered as illustrative and not restrictive and the invention is not to be limited to the details given herein but may be modified within the scope of the appended claims.

What is claimed is:

1. An auxiliary machine mounting structure for an engine, said structure comprising the auxiliary machine for the engine and plural mounting portions formed on an outer circumferential surface of the machine so as to protrude therefrom;
said plural mounting portions being fixed firmly to a bracket of the engine by inserting bolts through each mounting hole bored in each mounting portion; and
wherein each mounting hole is a longitudinal hole such that each bolt when inserted through the respective holes, has a predetermined angle to the axis of the bolt when fixed to the engine.

2. An auxiliary machine mounting structure for an engine according to claim 1,
wherein said mounting hole is bored in each mounting portion, perpendicular to the drive shaft of the machine, and
wherein the longitudinal direction of the longitudinal mounting hole is a radial direction of a main body of the machine.

3. An auxiliary machine mounting structure for an engine according to claim 2, wherein said mounting hole is a tapered hole.

4. An auxiliary machine mounting structure for an engine according to claim 3, wherein said mounting hole is bored such as at least two axes intersect therein.

5. An auxiliary machine mounting structure for an engine according to claim 4, wherein said bolt is one with hexagon socket head or one with dodecagon socket head.

6. An auxiliary machine mounting structure for an engine according to claim 1, wherein said mounting hole is a longitudinal hole without constriction.

7. An auxiliary machine mounting structure of an engine according to claim 1, wherein said mounting portions are at least two.

8. An auxiliary machine mounting structure for an engine according to claim 2, wherein the longitudinal length of said longitudinal mounting hole is adjustable.

9. An auxiliary machine mounting structure for an engine according to claim 4, wherein said intersection between two axes is positioned such as the distances between the opposite openings of the mounting hole and the intersection are equal.
